(19) United States
(12) Patent Application Publication
(10) Pub. No.: US 2017/0235962 A1
(43) Pub. Date: Aug. 17, 2017

(54) Secure Electronic Keypad Entry

(71) Applicant: Jonathan A Clark, San Jose, CA (US)

(72) Inventor: Jonathan A Clark, San Jose, CA (US)

(21) Appl. No.: 15/272,427

(22) Filed: Sep. 21, 2016

Related U.S. Application Data
(63) Continuation of application No. 62/221,616, filed on Sep. 21, 2015.

(51) Int. Cl. G06F 21/60; G06F 21/84; G06F 3/0488; G06F 21/83

(52) U.S. Cl. CPC G06F 21/60; G06F 21/83; G06F 21/84; G06F 3/04886

(57) ABSTRACT

An electronic device and method for securely receiving and communicating confidential information. The device comprises a user-defined variable and programmable randomizer module that randomizes a display of at least one of a plurality of data components of a security data interface (“SDI”). Display features of the data components of the SDI, such as location, layout, movement, and/or sequence, are randomized and stored in memory, then driven by a display driver circuit (“DDC”) to generate the randomized SDI on a display device. An exemplary circular keypad SDI having digits from 0-9 has a random anchor position, continuous rotation and translational movement during or between data entry by a user to select credit card (“CC”) number via the SDI for a secure transaction that is resistant to detection and interception.

### CROSS-REFERENCE TO RELATED APPLICATIONS

This application claims priority to U.S. provisional application(s): Ser. No. 62/221,616 filed Sep. 21, 2015, entitled “Secure Electronic Keypad Entry,” with the same inventor as the present application, which application(s) are also incorporated by reference herein in their entirety. Furthermore, where a definition or use of a term in a reference, which is incorporated by reference herein, is inconsistent or contrary to the definition of that term provided herein, the definition of that term provided herein applies and the definition of that term in the reference does not apply.

### FIELD OF TECHNOLOGY

This disclosure relates generally to the technical field of data security, and in one example embodiment, this disclosure relates to a method, apparatus and system for the secure entry of confidential information on an electronic keypad.

### BACKGROUND

It is necessary to communicate confidential or private information electronically for an increasing number of personal, medical, and financial matters. For example, the Internet is used for purchasing products, executing investment decisions, checking status of financial accounts, accessing and entering data for health care and medical needs, etc. To access these accounts or to make purchases, secure data is entered in the form of primary account number (“PAN”), credit card (“CC”) information, social security numbers (“SSN”), passwords, passcodes, and other personal information. There is an increase in the theft of personal and confidential information, due to the sophistication of hackers, and due to the weakness of some interfaces that communicate personal and confidential information.

One of the ways that a local system can be compromised is with a keystroke recorder or other devices that record the data being entered by the user on a keyboard, or on a static graphical user interface (“GUI”) on an Internet browser. Thus, even before the data enters the Internet via a Wi-Fi hotspot, or an edge server, the data may be already compromised. In fact, using a keyboard to enter confidential data will have the effect of bringing a local machine, and therefore local network, in to scope for all 240 Payment Card Industry (“PCI”) requirements, which is very expensive, and time/resource consuming.

In other scenarios, a static GUI displayed on a touch screen for a smartphone login or on a touch screen entry point to a secure room or even into a country can be compromised by guessing the passcode by looking at the fingerprints and smudge marks on the touch screen. For example, if a four-digit passcode is used on a static GUI, and if four smudge marks appear on the touch screen, then only about 24 sequence combinations exist, which can be completed quickly.

### SUMMARY

An electronic device, method, and system for securely receiving confidential information. The electronic device comprises a randomizer module to randomize at least one of a plurality of data components of a security data interface (“SDI”) version of a graphical user interface (“GUI”); a memory for storing the data components of the SDI; a display driver circuit (“DDC”) for generating and driving a display image; a display device for actually displaying the SDI having at least one randomized data component; and an input device to receive external information via the SDI to identify and input the confidential information, e.g., selecting the numbers displayed by the SDI to identify a credit card (“CC”) number. Using the randomizer module of the present disclosure transforms the display device from a deterministic display of the SDI to a randomized display of the SDI for secure receipt of the confidential information.

A randomized SDI can be used within a standalone device, e.g., a mobile device, for processing of login password confidential information. In this embodiment, the apparatus and method for randomized SDI is contained within the standalone device. Alternatively, a randomized SDI can be used in a network communication between electronic devices, for processing of login password confidential information or transmitting financial and personal information from one device to the other. In this latter embodiment, the apparatus and method for randomized SDI is distributed in both electronic devices.

Initially, a user such as a commercial or retail enterprise sets up the population of data components of the SDI in the memory of the electronic device. For example, data components can include data entries such as an alphabet of any language, numbers, ASCII characters, icons, pictures, or other data can be used as the data components of the SDI. In this manner, the SDI will present the data components of the SDI in a range of randomization for a user to select for a given application, such as a logon to an account or a smartphone, or to provide a CC for an online purchase. If a customer only has CC information to be entered, then only numeric data components are required to be entered. If words or letters are needed, then an alphabet is entered as the data components of the SDI. Functions and commands can also be entered as data components of the SDI.

A user also initially records desired randomization settings and configurations for a variable and programmable degree of randomization for the SDI. By doing so, the user can select the desired balance of customer convenience and ease of use versus degree of randomization, which usually increases effort and time required by the user. Thus, a user can configure, or reconfigure (e.g., via an initialization of the electronic device) the degree of randomization based on feedback from customers and hacking attempts, without having to redesign a custom security interface system. Randomization settings for the randomizer module will result in the randomization of the display of the at least one of the data components of the SDI by one or more category of (i) a location of the SDI driven by the DDC; (ii) a layout (or format) of data components of the SDI driven by the DDC; (iii) a movement of the SDI by the DDC during receipt of external information on the SDI; and (iv) a sequence of the data components of the SDI as driven by the DDC. For example, the location of the SDI refers to a random index, or anchor, start location for the SDI data entry population (e.g., the sequence of numbers 0-9) on the display device. The layout of the data components is a size of the buttons for each of the data components (e.g., 0-9), and the pattern that the buttons make when arranged together, among other options. The movement of the SDI can occur continuously (floating) during data entry, or can be static until a certain quantity of data entries are made by the user, and then a step movement of the SDI to a new random location will occur. The movement of a circular keypad can be linear or rotational (clockwise (“CW”) or counter-clockwise (“CCW”). The sequence of the data components refers to whether the data components are sequential (increasing 0-9 or decreasing 9-0) or in a random sequence. The sequence or layout can be CW or counter-clockwise CCW. Thus, a sequence of data components can be CW sequential, while the movement of the SDI can be counterclockwise in a floating manner. Combining multiple categories has the effect of multiplying the randomness of the SDI, and commensurately decreasing the probability of reverse engineering or interception of entered confidential information via the SDI.

In operation, the randomizer module is implemented on either logic circuitry or on a processor executing code in the form of an algorithm and other instructions that result in the transformation of the electronic device, namely the display device, from being a deterministic display of the SDI to a randomized display of the SDI for secure receipt of the confidential information. For example, either deterministic or non-deterministic pseudo-random number generators can be used in the present embodiment, since the generator is not generating a numeric sequence, but rather a display (position, layout, location, key size, etc.) that is in turn selected by a user (an analog input). In addition, with the combination of randomizations specified in this disclosure to obtain a single data entry, the overall randomness of the selection approaches non-deterministic, even though the individual operations may have less randomness than desired. For example, a deterministic core generator such as Mersenne Twister can be used for the initial index location of the SDI, for the rotation of the circular keypad, for the linear translation, for the sequence direction, etc., all of which can be combined to occur at a single event, e.g., between two data entries, or that can be individually separated and executed serially over time, or across multiple data entries. The randomizer module executes the user defined randomization settings to define a location for each of the data components of the SDI (e.g., location of digits 0-9) and stores this in memory associated with the data component. The memory is then accessed by or for the DDC, e.g., by a controller or microprocessor, or combinational logic, to drive the SDI display to the display device. A user can then view the SDI on the display device, and use a touch screen or mouse clicks to select the desired data component(s), e.g., in series, of the SDI to effect a secure communication of confidential information, such as a CC. While the user is entering data selections via the SDI, randomization settings are constantly being evaluated and executed per the user-defined randomization settings, e.g., the SDI incrementally moves linearly, or rotates, and/or changes format, etc. while the user is entering data.

Execution of the user-defined randomization settings can be either by deterministic pseudo-random algorithms, or by non-deterministic random algorithms, though the former is sufficient in the present embodiment. With the combination of multiple randomization operations described above, even the deterministic pseudo-random algorithm can approach a non-deterministic effect of randomization.

In this manner, the present disclosure eliminates the storage of data in a keyboard buffer that otherwise can be retrieved and reverse engineered by an unauthorized party to determine confidential information such as passwords, usernames, CCs, etc. Instead, the present disclosure allows the secure entry of personal information, such as a primary account number (“PAN”) (e.g., CC), username, password, social security number, or other personal information.

The methods, operations, processes, systems, and apparatuses disclosed herein may be implemented in any means for achieving various aspects, and may be executed in a form of a machine-readable medium, and/or a machine accessible medium, embodying a set of instructions that, when executed by a machine or a data processing system (e.g., a computer system), in one or more different sequences, cause the machine to perform any of the operations disclosed herein. Other features will be apparent from the accompanying drawings and from the detailed description that follows. Accordingly, the specification and drawings are to be regarded in an illustrative rather than a restrictive sense.

### BRIEF DESCRIPTION OF THE VIEW OF DRAWINGS

Example embodiments are illustrated by way of example and not limitation in the figures of the accompanying drawings, in which like references indicate similar elements and in which:

FIG. 1 is a functional block diagram of a randomizer module, according to one or more embodiments.

FIG. 2 is a block diagram of a network system of a server and an electronic device for communicating secure data via a randomized secure data interface (“SDI”), according to one or more embodiments.

FIG. 3A is a workstation electronic device for implementing a randomizer module for the secure entry of data, according to one or more embodiments.

FIG. 3B is a mobile electronic device for implementing a randomizer module for the secure entry of data, according to one or more embodiments.

FIGS. 4A-4C are memory with randomized display data entries for SDI data components, according to one or more embodiments.

FIG. 4D is a data register of programmable and variable user-defined randomization settings for the SDI, according to one or more embodiments.

FIGS. 5A-5Q are display devices illustrating different embodiments of randomized SDIs, according to one or more embodiments.

FIG. 6 is a flowchart of a method to randomize an SDI to provide secure entry and transmission of confidential information, according to one or more embodiments.

The drawings referred to in this description should be understood as not being drawn to scale, except if specifically noted, in order to show more clearly the details of the present disclosure. Same reference numbers in the drawings indicate like elements throughout the several views. Other features and advantages of the present disclosure will be apparent from accompanying drawings and from the detailed description that follows.

### DETAILED DESCRIPTION

A method, apparatus and system for the secure entry of confidential information on an electronic keypad is disclosed. In the following description, for the purposes of explanation, numerous specific details are set forth in order to provide a thorough understanding of the various embodiments. It will be evident, however to one skilled in the art that various embodiments may be practiced without these specific details.

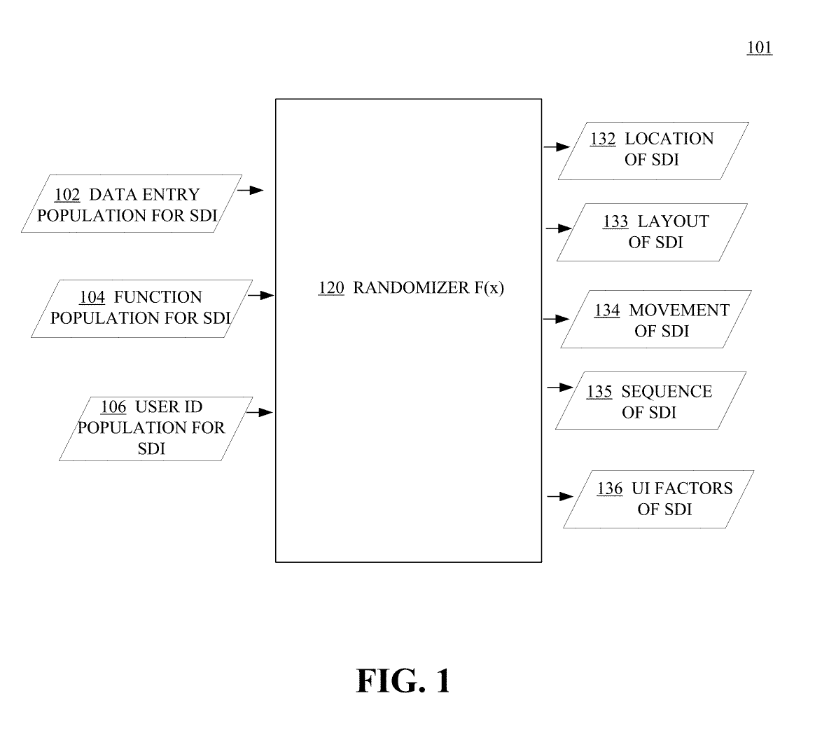

Referring now to FIG. 1, a functional block diagram 101 is shown of a randomizer module, according to one or more embodiments. A programmable (parameter setting) and variable randomizer module 120 receives data entry population 102 for the security data interface (“SDI”) (e.g., 0-9 numerical digits, or a-z alphabet letters, etc.), receives function population 104 (e.g., clear, reset, cancel, for the SDI, and recites user ID population 106 for SDI. In one embodiment, the population of a data entry can be abbreviated to a smaller set than the entire population. These inputs are the values that will be graphically displayed on the SDI on a display device for a user or external input to select based on the position of the desired value (number, letter, function) in the display device. This is an alternative method of entering data over a keyboard with keystrokes that have security risks due to unapproved use of keystroke recorders, and buffer memory recording and/or intercept of explicit keystroke values.

Outputs of the randomizer module functional block 120 include location 132 of the SDI, layout 133 of the SDI, movement 134 of the SDI, sequence 135 of the SDI, and user interface (“UI”) factors of the SDI. Specific embodiments for these outputs are provided below. By controlling and varying these outputs of the SDI, the randomization of the SDI is increased and security of enhanced for confidential data entered via the SDI.

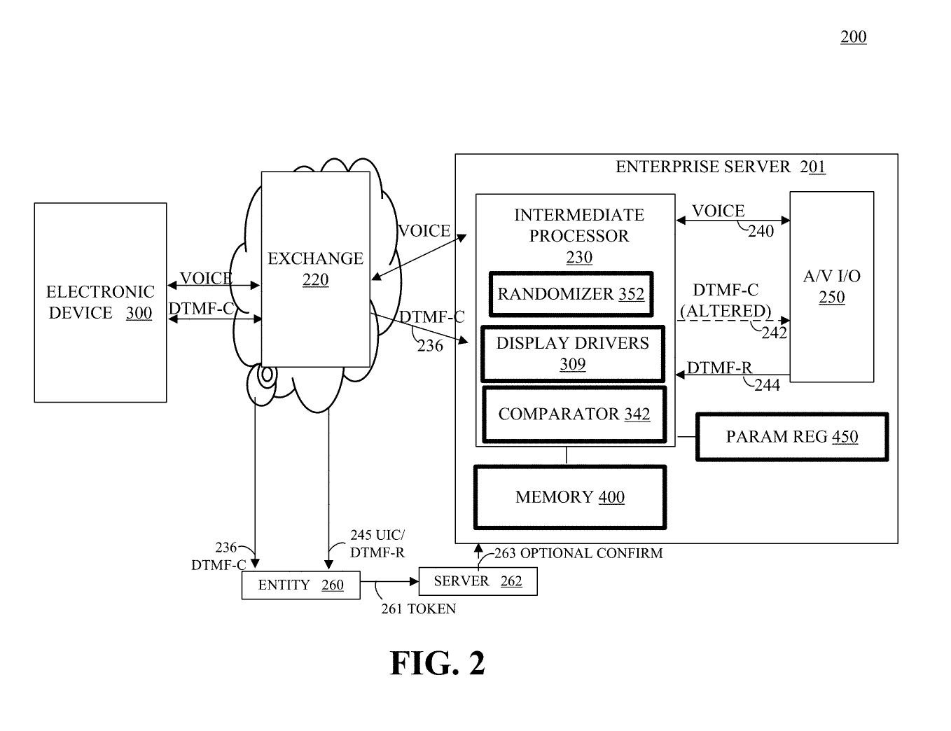

Referring now to FIG. 2, a block diagram is shown of a network system 200 of a server 201 (second communication node) and an electronic device 300 (first communication node) for communicating secure data via a randomized secure data interface (“SDI”) (illustrated in subsequent figures), according to one or more embodiments. More information on network system 200 in a payment card industry (“PCI”) environment with token processing is disclosed in commonly owned US publication 20130077773, entitled “SECURE PROCESSING OF CONFIDENTIAL INFORMATION ON A NETWORK” by Jonathan Clark, and filed Sep. 20, 2012, which is incorporated herein by reference, in its entirety.

Enterprise server 201 includes an intermediate processor 230 that in turn includes randomizer 352, and display drivers 309, and optional comparator 342. Randomizer 352 provides randomization of the SDI in order to increase security for entering confidential information. Randomizer 352 can be a logic circuit that provides a hardwire solution for low latency response. Alternatively, randomizer 352 can be an algorithm, or a call function, that is implemented using code stored in memory 400 and executed via intermediate processor 230, or another controller or co-processor. Instructions for the algorithm and call functions to implement randomizer 352 are provided in flowchart 600, and can be stored in memory 400. Enterprise server 201 further includes parameter registers 450 (aka, param reg), such as a flip-flop array, for storing the user-defined parameters for the desired degree of randomization of the SDI, as mentioned in FIG. 1, such as location, layout, movement, sequence, and UI factors of the SI (such as other optical triggers such as color, flashing on/off, etc.). Other types of memory may be used to store these configuration or parameter values as well. Comparator 342 is an optional module or logic that would compare a (non-reversible) hash value of a master key, stored in param reg 450 or in memory 400 to be compared against an input response from electronic device 300, e.g., a user inputs a user ID and password at the electronic device 300 via the SDI. The user ID and password is then compared via comparators 342 to a master key user ID and password stored in memory 400 or param reg 450 in enterprise server 201.

The present embodiment distributes the randomizer operation across two networked electronic devices. The randomizer function of generating a randomized SDI is performed in enterprise server 201, and is driven by display drivers 309 for html browser language to be displayed on a display of electronic device 300, where external data is input by a user via the SDI, and communicated back to the enterprise server 201 for evaluation.

The system 200 includes at least a second communication node, e.g., enterprise server (aka receiver) 201, and optionally a server 262 (for token processing), as either on-site or a third-party remote server farm, coupled to each other, both of which a company performing transactions in the network would own or have control. In particular, an enterprise company would control receiver 201, even if receiver 201 is distributed to agents for remote field use in for effecting sales with a caller via the communication network. In terms of controlling its functionality, the company would control and manage the identity, and registration of receiver 201 with entity 260, for purposes of maintaining security of the system and confidential information passed between the communicatively coupled blocks of: caller (via electronic device) 300, exchange 220, receiver 201, entity 260 and company 262. The audio/visual input/output (A/V I/O) 250 of receiver 201 allows an agent associated therewith to communicate, verbally and optionally by text, with caller 300 to receive voice signal audio output from receiver 201, and to input customer information of caller 300, other than confidential billing information (“CBI”), into an order system database, and to then direct the system to complete a transaction by secure payment using a balance of the system 200. Receiver 201, intermediate processor 230 and A/V I/O 250 can be a wide range of communication devices and systems with the ability to communicate with a caller 300 to affect a sale of goods or services to the caller 300, who is a customer. For example, receiver 201 can be a traditional twisted pair line in a private branch exchange (PBX), with intermediate processor 230 being the switching equipment therein, and the A/V I/O 250 being a plain old telephone system (POTS) with or without digital readout. Alternatively, receiver 201 can be an Internet protocol (VOIP) system with intermediate processor 230 being a router and/or switch, hub, etc., and with voice signal 250 being the individual lines and phones. In one more embodiment, receiver 201 can a personal communication device, e.g., a wireless mobile device such as a cell phone, smart phone, tablet, handheld, laptop, or any other electronic device with the ability to communicate voice signals.

Caller 300 is coupled to exchange 220 that can be a discrete physical location, or can be virtually located in the Internet, aka, ‘the cloud.’ Exchange 220 can be any communication interchange provided by a communication company such as a cell phone company, a landline company, an internet service provider, etc. In one embodiment, exchange 220 is a phone switching office, a mobile telephone switching office, or the many devices that compose the Internet. Exchange 220 is coupled to receiver 201.

A caller initiating a call to another person or a company to conduct business, which invariable includes the exchange of confidential billing information (CBI) such as credit card, debit card, banking information, etc., or sharing of other confidential information, will provide this confidential information typically by depressing keys on their communication device, e.g., cell phone or push button telephone. The push buttons generate the DTMF signal, whether organically from their phone or from a code-activated remote source, that is typically transmitted over a separate channel than the voice signal, as shown by two separate connections between caller 300 and exchange 220. Regardless, the present disclosure is also well suited to providing secure processing of confidential information on a network for a single signal contained both voice signal and confidential (information) signal, e.g., in an encrypted format.

With the traditional case of separate channels, the confidential information signal, referred to as caller (electronic device) 300 DTMF (DTMF-C) 236 and the voice signal of the caller are communicated from caller 300 to exchange 220 to receiver 201. At receiver 201, the voice signal and the DTMF-C signal are processed by intermediate processor 230. The DTMF-C 236 signal input to intermediate processor 230 can be used, in appropriate configurations such as a PBX, to navigate a service of tone-driven user interactive menus (UIM), for the caller 300 to select the desired information, extension, department, service, goods, etc. Intermediate processor 230 also performs the function of rendering the DTMF unusable, shown as DTMF-C (altered) 242, for downstream access by voice signal 250, whether by jack, speaker, etc. The DTMF-C altered 242 signal includes cases of providing no DTMF signal output whatsoever, or providing a confounded signal output that could not be used to determine the original input DTMF-C signal 236. This security function is provided on a full-time, continuous basis in the present embodiment, though another embodiment allows the company to disable it selectively, e.g., for performing security checks or audits.

The purpose of this disclosure is to prevent a listener of voice signal at A/V block 250, e.g., a call-order agent, from having any access to the CBI of caller 300. While the call-order agent may have access to customer information such as name, address, etc., the call-order agent is segregated from the CBI, so that they have insufficient information for conducting any unauthorized purchases using the customer's CBI such as their credit card number. By not having access to the CBI, the agent is then always out of scope for purposes of Payment Card Industry Data Security Standard (PCI DSS). Consequently, the company or person utilizing this system and method will have a lower potential for conversion or misappropriation of caller confidential information, will have reduced costs from lower administrative oversight and PCI compliance duties, will enable remote home-agents to utilize the system with equal or greater security than on-site concentrated call centers and at lower cost, more flexible work force, localized service to callers, etc. Compared to other systems, where a listener/agent has to manually select a mode of disabling a DTMF-C signal from being passed to the agent, which still has the possibility for fraud and does not take the agent out of PCI scope, the present disclosure is guaranteed to not pass any caller confidential information to a listener/agent downstream of the intermediate processor, while still providing all the other expected services such as UIM and agent enabled communication of DTMF from her communication device to the intermediate processor and further downstream

Entity 260 is a secure processing facility for handling, among other things, the CBI of caller 300, e.g., the DTMF-C 236 tones. Entity 260 can be a tokenization as a service (TAAS) entity, or some other entity, which could be managed by a third party either on-site or remotely by the third party, for providing the secured transactions in scope for PCI DSS. Entity 260 can be communicatively coupled to exchange 220, or to receiver 201 via some other route, medium, or protocol. e.g., via different versions of Layers 2 and 3 of the open standard interconnect (OSI). Subsequent figures provide explanations for alternative embodiments. Entity 260 provides a function of validating the agent who received the voice signal 250 and is working to complete a transaction with the caller 300. In particular, entity 260 compares the incoming call from the agent against a list of previously registered users. e.g., in a look up table on a computer memory, to verify that, based on a unique identifier code (UIC) of the call from the agent from receiver 201, that the agent/receiver 201 is a legitimate agent/receiver. The UIC can include unique identifiers of the agent/receiver 201 such as a media access control (MAC) address, an Internet protocol (IP) address, a subscriber identity module (SIM) card number from a personal communication device, or other similar unique identifiers. Once verified, entity 260 generates a token that is based on the receipt of the confidential information of the caller 300, received from receiver 201. Subsequent figures provide explanations for alternative embodiments of communicating between entity 260 and receiver 201 regarding communicating token information to receiver or to server 262.

In particular, exchange 220 is coupled to entity 260 to receive the DTMF-C 236 signal from the intermediate processor 230 which ‘trombones’ the signal back to the exchange 220 for routing to the entity 260, at the instruction of the receiver 201, which instantiates a secure channel from either intermediate processor 230 to exchange 220 and/or from exchange 220 to entity 260. Agent at receiver 201 can instantiate the secure channel by DTMF signal DTMF-R 244 from agent keypad (not shown) via A/V I/O 250, which is communicable to intermediate processor 230, and thereafter from exchange 220 to entity 260 as signal DTMF-R 245 which includes the UIC of the receiver 201. Thus, as shown, the DTMF signaling between intermediate processor 230 to A/V I/O 250 is asymmetric, allowing one-way communication from A/V I/O 250 to intermediate processor 230 and the non-communication, at least of caller DTMF-C 236 from intermediate processor 230 to A/V I/O 250. DTMF-C channel 236 from intermediate processor 230 to exchange 220 can include DTMF-R signal 244 from agent inputting instructions/data from a receiver 201 origination. Once token 261 is generated by entity 260, it is passed to server 262, which provides a minimal completion of the transaction regarding the caller 300. Company of server 262 can then optionally provide a confirmation code 263 via any medium and format to user, e.g., typically by updating the sales order database that is being viewed by agent on a same device as receiver 201, or a separate device, e.g., a separate PC.

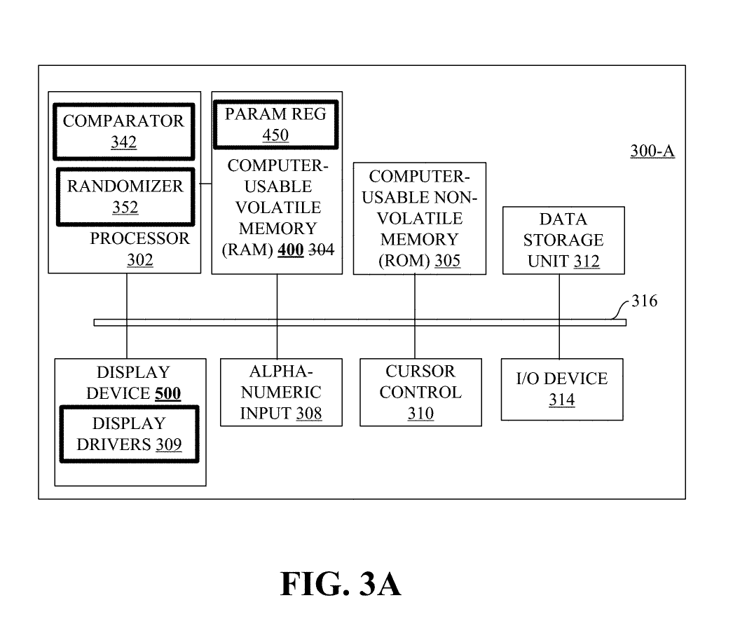

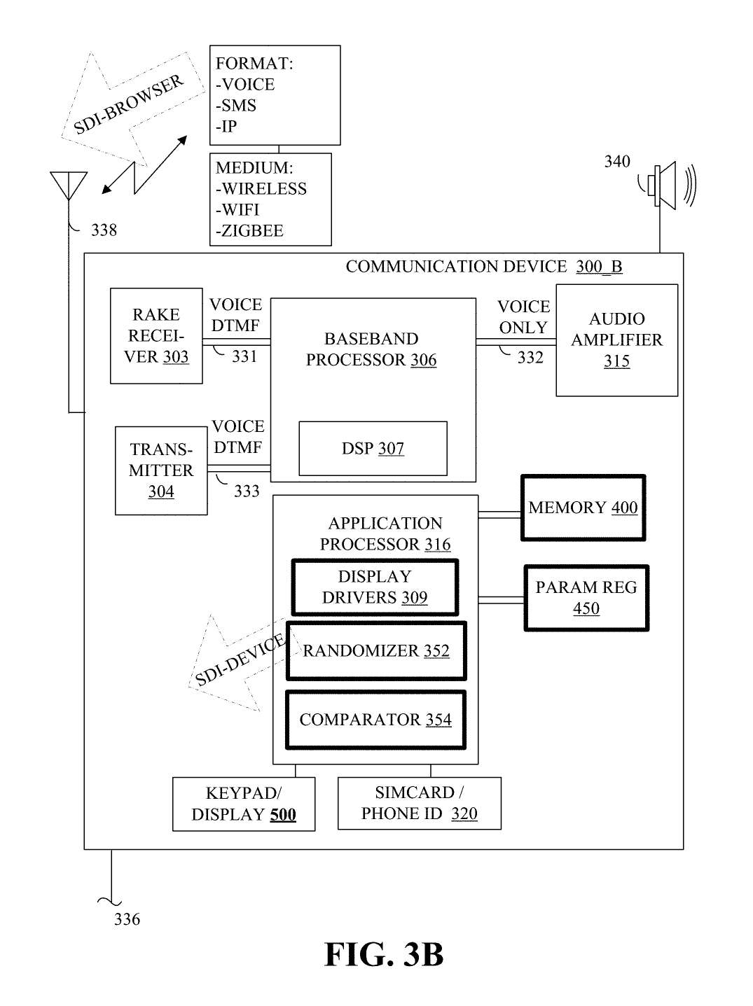

Referring now to FIG. 3A, a workstation electronic device 300-A is shown for having a randomizer module for the secure entry of data, according to one or more embodiments. Computing device 300 includes typical components such as a processor 302 coupled to a memory 400, 305, and/or 312. In particular, processor 302 can be a single or multi-processor core, for processing data and instructions. Memory 400, 305, and/or 312 are used for storing and providing information, data, and instructions, including in particular computer usable volatile memory 400, e.g. random access memory (RAM), and/or computer usable non-volatile memory 305, e.g. read only memory (ROM), and/or a data storage 312, e.g., flash memory, or magnetic or optical disk or drive.

Computing device 300 also includes optional inputs, such as: alphanumeric input device 308, such as: a keyboard or touch screen with alphanumeric, function keys, object driven menus; a keypad button, a microphone with voice recognition software running on a processor, or any device allowing a player to respond to an input; or an optional cursor control device 310, such as a roller ball, trackball, mouse, etc., for communicating user input information and command selections to processor 302; or an optional display device 306 coupled to bus for displaying information; and an optional input/output (I/O) device 314 for coupling system with external entities, such as a modem for enabling wired or wireless communications between system and an external network such as the Internet, a local area network (LAN), wide area network (WAN), virtual private network (VPN), etc. Coupling medium 316 of components can be any medium that communicates information, e.g., wired or wireless connections, electrical or optical, parallel or serial bus, etc.

If electronic device 300-A is used as a standalone device, e.g., for randomizing the SDI and for accepting user ID and PW to access the electronic device 300-A itself, then randomizer 352, parameter registers 450, and display drivers 309, along with the aforementioned components of the device 300-A, are used to implement the display of the SDI via I/O device 314 (e.g., a display device output to display the SDI), and a similar or different I/O device 314 (via a touch screen input or a mouse input for a non-touch screen) to enter confidential information via the SDL displayed on the display. The implementation of these components with the same name as described for FIG. 2.

The computing device is only one example of a suitable computing environment and is not intended to suggest any limitation as to the scope of use or functionality of the present technology. Alternatively, electronic device 300-A can be a thin client, e.g., a dumb device, which only has a capability or is only used to a capability of displaying results and accepting inputs, e.g., not requiring comparator 342, randomizer 35, and parameter registers 450. As a thin client, device 300-A would receive randomized SDI that was generated by enterprise server 201 of FIG. 2, and display same on I/O device 314 (display device) as previously described. Neither should the computing environment be interpreted as having any dependency or requirement relating to any one or combination of components illustrated in the exemplary computing system. The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

Electronic device 300 can be any device with an interface for displaying an SDI and receiving an input, including a wireless portable device, a mobile communication device, a mobile phone, or computer screen, a dumb terminal, a thin client, a watch, a server, etc.

Referring now to FIG. 3B, a mobile electronic device 300-B is shown for implementing a randomizer module for the secure entry of data, according to one or more embodiments. Device 300-B is a personal communication device in one embodiment that includes operational hardware such as a rake receiver 303 to receive signals from antennae 338 and communicate both the voice and DTMF 331 to baseband processor 306 with digital signal processing (DSP) 307, which provide the CODEC/MODEM functions for signal processing. Alternatively one or more signals may be provided by wired connection 336, such as Ethernet, coaxial, or optical cable, etc. Baseband processor 306 is configured to provide only recognizable voice output 332 to audio amplifier 315, coupled thereto, in order to be compliant with not providing any incoming caller DTMF confidential information to the listener/agent of communication device 300. This can be implemented in one of multiple methods. First, if the DTMF confidential information is provided via a separate channel from voice data to device 300, then the baseband processor can be configured either permanently or selectively to not combine the demodulated and/or decoded signals from the DTMF confidential information signal with the voice signal. If selectively done, then an application processor or other means could be programmed to allow only a company or person with administrative authorization to change. Alternatively, the application processor can contain authorization and password protected software that configures the baseband processor to perform alternative techniques to render the DTMF tones unusable as previously described, such as tone flattening, superposition of random or superset of tones, etc. SIMcard/caller identification block 320 provides the identification features used by entity 160 of FIG. 1B-1E, via transmitter 304 and antennae 338 or cable 336, to verify the identity of the agent providing the service for the caller. Keypad/display 500 coupled to baseband processor and application processor allows the agent/user of device 300 to input data and instructions to configure the system, open secure channel for completing the transaction.

If electronic device 300-B is used as a standalone device, e.g., for randomizing the SDI and for accepting user ID and PW to access the electronic device 300-A itself, i.e., to turn on and operate the cell phone, then randomizer 352, parameter registers 450, and display drivers 309, along with the aforementioned components of the device 300-B, are used to implement the display of the SDI via keypad display 500 (e.g., a display device output to display the SDI), and a similar or different I/O device 500 (via a touch screen input or a mouse or arrow buttons for a non-touch screen) to enter confidential information via the SDL displayed on the display. The implementation of these components is similar to those components with the same name as described for FIG. 2.

The computing device 300-B is only one example of a suitable computing environment and is not intended to suggest any limitation as to the scope of use or functionality of the present technology. Alternatively, and in addition to a standalone embodiment, electronic device 300-B can be a thin client, e.g., a dumb device, which only has a capability or is only used to a capability of displaying results and accepting inputs, e.g., not requiring comparator 342, randomizer 35, and parameter registers 450. As a thin client, device 300-B would receive randomized SDI that was generated by enterprise server 201 of FIG. 2, and display it on keypad/display 500 (display device) as previously described. Thus, mobile device 300-B can use a standalone device that implements a randomized SDI to login to the device 300-B for accessing a WiFi Internet browser. Thereafter, device 300-B is used as a thin client to receive a randomized SDI from an external source, such as enterprise server 201 of FIG. 2, to validate the user to access a financial account, or to purchase products at a website. The randomized SDI can be very different for the standalone device versus the external server 201, based on the programmable variable randomization settings selected by the user or the host. Neither should the computing environment be interpreted as having any dependency or requirement relating to any one or combination of components illustrated in the exemplary computing system.

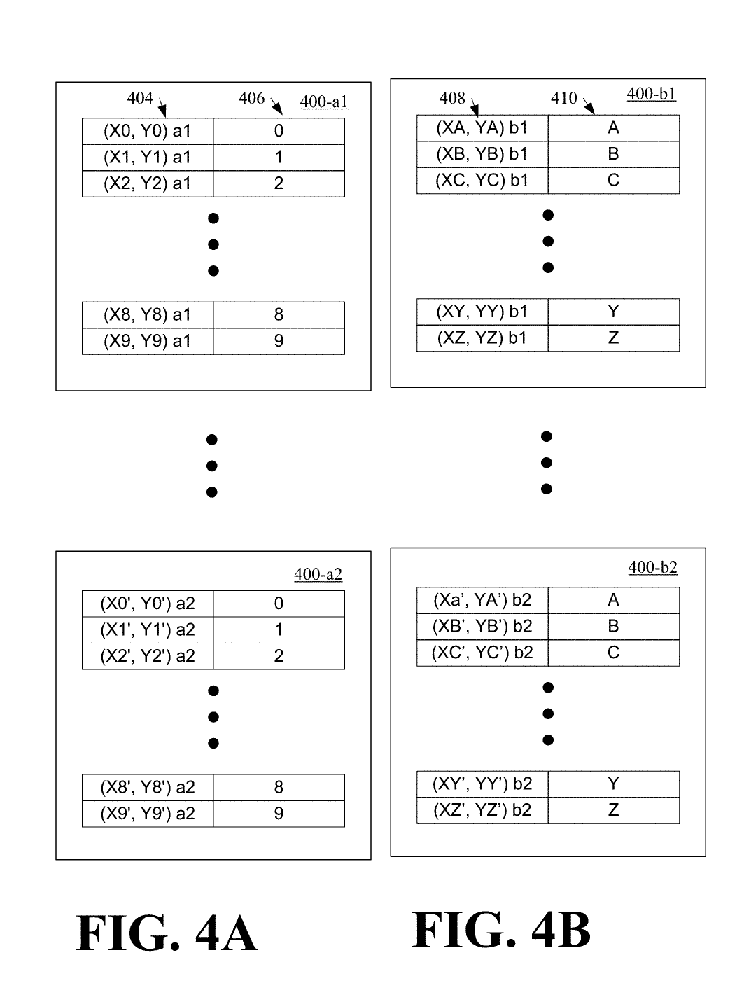

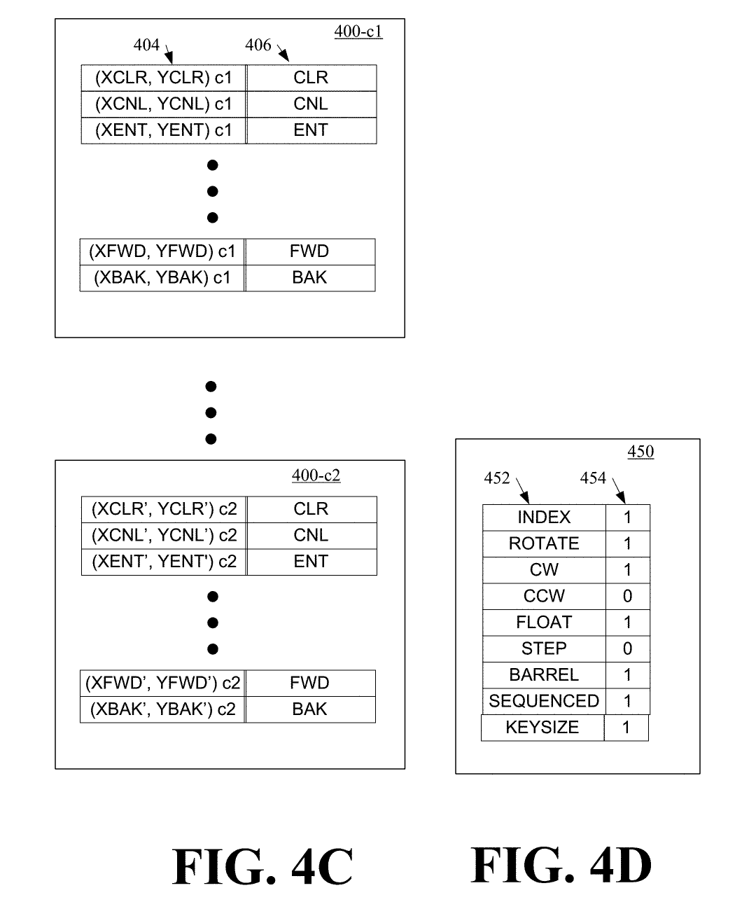

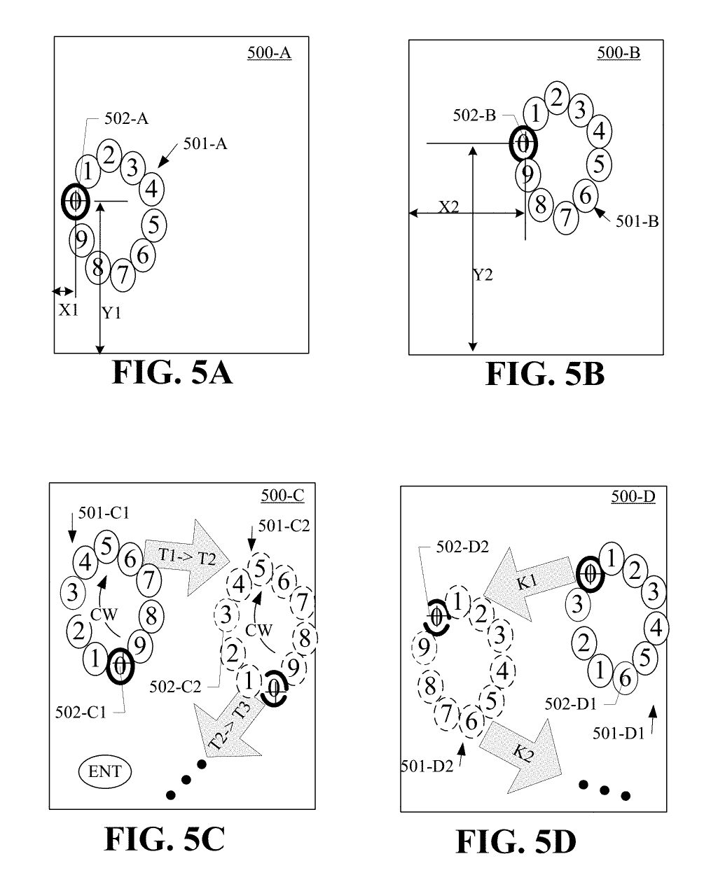

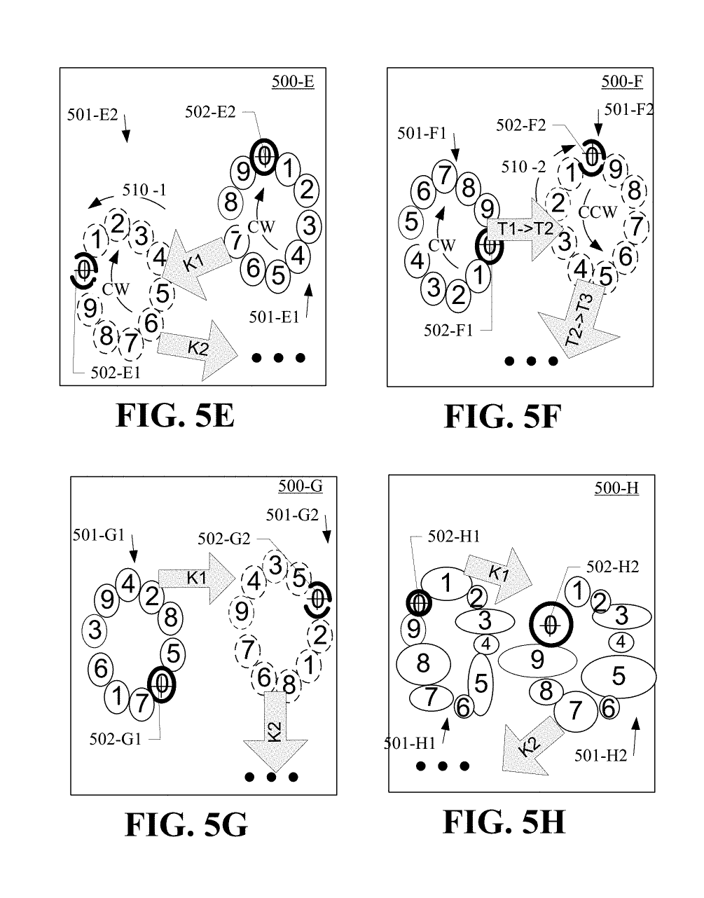

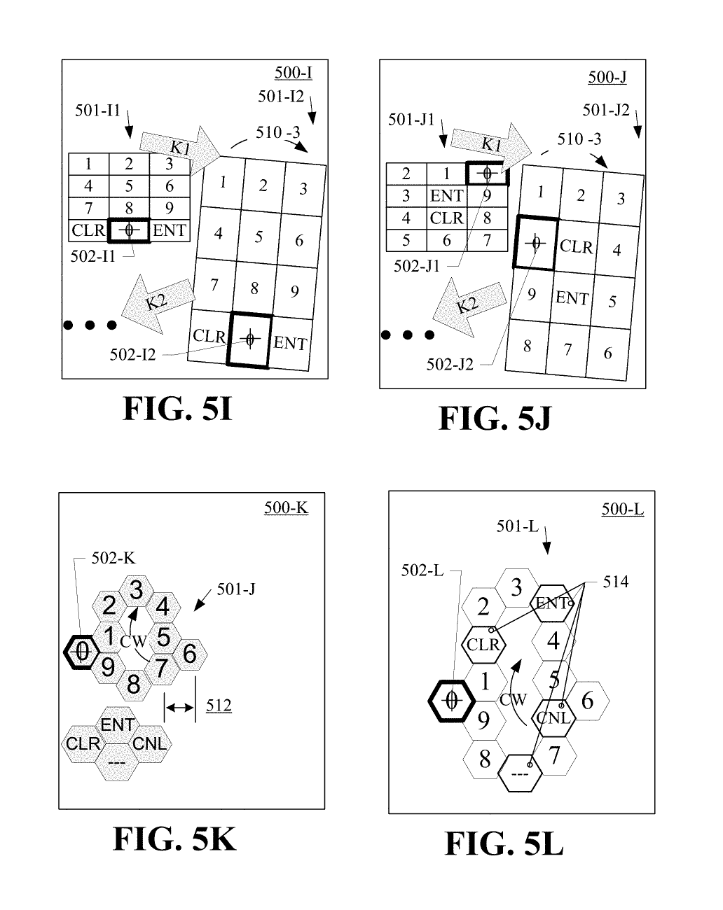

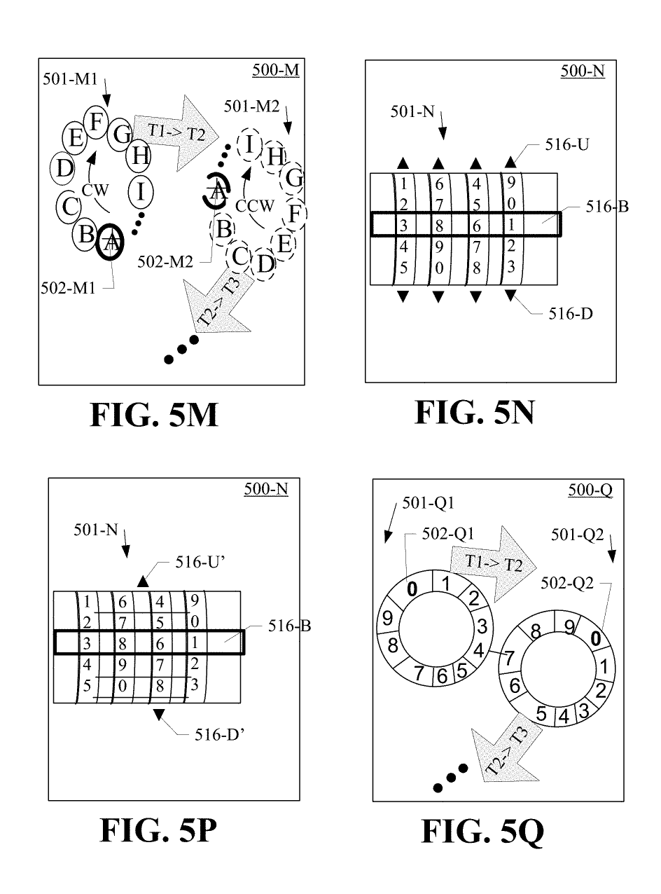

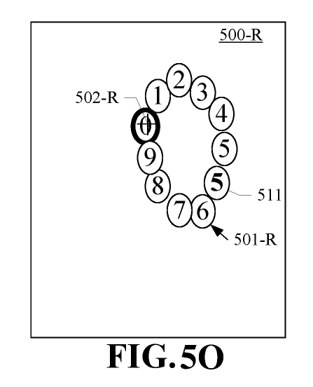

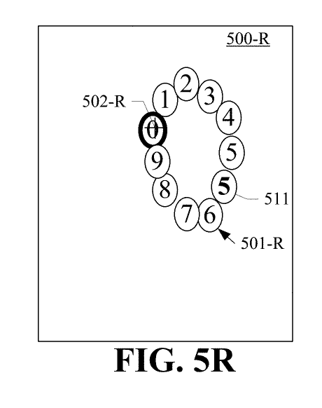

Referring now to FIGS. 4A-4C, memory is shown with randomized display data entries for SDI data components, according to one or more embodiments. Memory 400-a1 indicates the location in column (404) for a data component in column 406. Thus, for data component “0” of the SDI, a value of “(X0, Y0) a1” is shown for creating a button with the value of “0” on a display device of FIG. 2 or 3A to 3B to create a SDI image on a display device, such as shown in FIGS. 5A-5N. The ‘a1’ value denotes a given time, i.e., an initial anchor position of the ‘0’ data component of the SDI (wherein ‘0’ happens to be the anchor digit for the SDI), and other parameters for the data component, such as a key size created for the display of value ‘0’. The same description applies to the balance of the data component population (1-9) for this particular choice of numbers as the data component for the SDI, to create a SDI image on a display device, as mentioned above.

Memory 400-a2 similarly indicates the location for the respective data component, albeit at a different time, or after an event (e.g., either a continuous movement of the SDI per the user-defined parameters, or after an entry of “1” or a specified quantity of inputs via the SDI, per the user-defined parameters). Thus, data component “0” moves to a new location indicated by the prime symbol “(X0′, Y0′) a2, and with a2 also indicating a given time or event, and/or other data component properties (e.g., a size of the data component key can change after time or an event such as a data input). In this manner, the randomizer is constantly changing the display of the data components (e.g., location, layout, movement, sequence, or other UI factors) of the SDI, by their display address, as stored by the memory, and as executed by the display driver circuitry.

If a data component of the SDI uses alpha characters in lieu of numbers, then memory 400-b1 and b2 operate similarly to the memory of 400-a1 and a2. Yet again, memory 400-c1 and c2 in FIG. 4C operate similarly as memory and data components of FIGS. 4A and 4B, but for a function population 104, as described in FIG. 1. The function calls do not have the same level of confidential information as a user ID, password, or other personal information such as a SSN. Thus, a user may opt to avoid the same high level of randomization for the function components as for the data components of the SDI.

Memory 400-a1, a2, b1, b2, c1 and c2, et al., are implemented by memory hardware 400 shown in FIGS. 2A and 3A and 3B, depending on the configuration and use of the electronic device as a standalone or as a dumb, or servant device to a master device.

Referring now to FIG. 4D a data register 450 is shown of programmable and variable user-defined randomization settings for the SDI, according to one or more embodiments. In the present embodiment, column 452 indicates exemplary and non-exhaustive list of categories for randomization of the SDI, as offered by the algorithm. The general categories of location (Index), layout (CW, CCW, RANDOM, KEYSIZE, etc.), movement (FLOAT, STEP, or the implied STATIC if neither FLOAT or STEP is chosen), sequence (CCW, CW, etc.), and other UI factors mentioned above is manifested. The user defined choice for the categories of randomization is reflected by a stored 1 (yes) or 0 (no), and stored in the register. A GUI with a same layout and choice offering can be displayed for initially configuring the randomization module.

Referring now to FIGS. 5A-5Q, display devices 500-A through 500-Q are shown illustrating different embodiments of randomized SDIs, 501-A through 500-Q, according to one or more embodiments. For the SDIs presented to the user, the desired values are picked out at different stages of randomness of the SDI. Thus, a first four-number set of a CC number, e.g., 2274, could be entered from either a static SDI, that was randomly located. After those four digit entries, the SDI is programmed to linearly translate, rotationally translate, reverse sequence direction (CW to CCW), and possibly change button size uniformly, or randomly within the circular keypad. Then the next four number sequence of the CC is entered, e.g., 5510, then the SDI randomizes again, like the example just given, etc. until the entire CC number is entered.

In particular, FIG. 5A shows a random static location of a circular layout keypad with sequential arrangement of the data components in a known apriori sequence (clockwise from 0 to 9) as separate keys (having a graphical boundary around each unique data component of the SDI. The keys have a uniform shape and size in the present embodiment, making it easy for a user to identify the value in the key and to select it. The SDI has an anchor (index) data component “0” disposed at random location 502-A, with an X1 and Y1 coordinate. Thus, for the entire entry of the confidential information in this embodiment, e.g., a password, the SDI remains in the same anchor position and the same key size and shape layout, and same key location and key sequence.

In FIG. 5B, the circular layout keypad has a same key size and shape layout and same key location and key sequence as that of FIG. 5A, but it has a different random anchor (index) location 502-B for data component “0”, with corresponding random X2 and Y2 Cartesian coordinates. But using a repositioning of the SDI between accesses, logins, or entry of (confidential) data using the SDI, hints or clues left on the display (such as smudge marks on frequently used keys), or repeated observations will be much less effective).

Referring now to FIG. 5C through FIG. 5G, circular keypads are illustrated in display screens 500-A through 500-G with different randomization in order to reduce the likelihood of unauthorized interception, replication, or reverse engineering of the authorized selected code. Specifically, FIG. 5C provides a unique anchor start 502-C1 of “0” the SDI 501-C1 in a CW sequence. During elapsed time from T1 (start) to T2 (a user-defined amount of time), the anchor key “0” of newly positioned SDI 501-C2 floats to position 502-C2, and retains the same CW sequence. The SDI continues to float and rotate from time T2 to T3, etc. (not shown) until the entire fixed length of confidential information is entered (or until an ‘ENTER’ (ENT) function key is selected. No rotation of the sequence of keys occurs in 500-C.

FIG. 5D is similar, but the relocation of the SDI from 501-D1 to 501-D2 occurs only after an event, such as an entry of one or more keys, e.g., K1. The next relocation of the SDI occurs after an entry of one or more keys, e.g., K2. The sequence remains consistent as clockwise. No rotation of the sequence of keys occurs in 500-C.

FIG. 5E, the translational relocation of SDI from 501-E1 to 501-E2 occurs after one or more preset keystrokes, per the user configuration, like FIG. 5D. However, in display 500-E, rotational movement 510-1 (counter-clockwise; the opposite direction as sequence of data components 0-9), of the SDI occurs from SDI 501-E1 to 501-E2. In

FIG. 5F, a plurality of randomizing changes occur to the display of the SDI. First, a continuous linear translational change occurs from location SDI 501-F1 to location 501-F2 during elapsed time T1 to T2. Second, the sequence of the data components is reversed, going from CW in 501-F1 to CCW in 501-F2. Third, the SDI is rotationally translated for index location of “0” from 502-F1 to 502-F2. The sequence of data components 0-9 remains the same, despite the change in rotation direction (CW to CCW). The combination of randomizing multiple display properties of the SDI significantly increases the resistance of the entry of confidential information from being intercepted or compromised. Yet, the retaining of a known apriori sequence, e.g., the sequence of keys from 0-9, makes the pattern instantly recognizable to a user entering data.

FIG. 5G creates yet more change combinations in the display of the SDI, this time including translational change from 501-G1 to 501-G2, rotational change of the “0” anchor index from 502-G1 to 502-G2, and newly including a random population of the data components in an unsequenced order, for both 501-G1 and 501-G2. Because the sequence of the data components is no longer maintained, it is substantially harder for a user to search and fine the desired key. In addition, inadvertent failures to enter the correct sequence of confidential information are likely to be more frequent. It is also more difficult for the user to select the desired key, as the distraction of non-sequential surrounding numbers confounds the operation. However, for highly confidential data, this combination of randomization of the SDI display does have an additional benefit of being difficult to reverse engineer.

FIG. 5H illustrates a feature of randomizing the key shape and size, with a linear translation, while maintaining an approximate rotational location and sequence of data components 0-9. This pattern can give the effect of having different key locations because the area in which an acceptable key selection occurs has changed, some narrower, and some broader. Thus, even if the SDI were not linearly translated and not rotationally translated, the change in the key size and shape could effectuate sufficient randomization to prevent unauthorized recovery or high-probability guessing of the confidential information sequence, e.g., a PW

FIG. 5I illustrates a square telephone keypad layout, that undergoes a linear translation of the “0” anchor from 502-I1 to 502-I2, a size change (enlargement), and a rotational change 510-3 from SDI 501-I1 to 501-I2 over keystroke events from K1 to K2.

FIG. 5J is also a square keypad, but with the numbers arranged circumferentially like a ring, with the function keys in the center. FIG. 5J undergoes both translational and rotational 510-3 repositioning from 501-J1 to 501-J2.

FIG. 5K utilizes a hexagonal key shape that is easier to stack and align, with some keys relatively in a CW sequence, but laterally offset 512, i.e., key 6, as an outlier, outside a normal elongated circle of keys. The initial anchor location of index “0” 502-K for SDI 501-J is a random position.

FIG. 5L intersperses functional keys in sequence with the otherwise sequential CW order of numerical keys, with a notable offset of key 0 and 6.

FIG. 5M illustrates an alpha data component population (A-Z), with a combination of randomization shown in prior figures, namely linear translation from 501-M1 to 501-M2 and rotational translation from index key “A” 502-M1 to 502-M2, along with a reversal of the sequence direction from DW to CCW over time period T1 to T2.

FIG. 5N is a so-called ‘padlock’ (aka tumbler) dial rotation SDI configuration 501-N. By clicking the arrows up 516-U or down 516-D, the correct numbers can be obtained for the rectangular window box, one tumbler at a time for all four tumblers.

FIG. 5O is a circular keypad 501-R comprised sequential keys of data components 0-9, but having an extra, duplicate key for “5”, item 511. While the sequential nature of the circular keypad is maintained, and the ease of finding a desired number still exists, the extra duplicate key has the effect of randomizing the location of the other keys in the circular keypad, thus making interception or reverse engineering more difficult for an unauthorized party. Multiple pairs of duplicate keys can exist in another embodiment.

FIG. 5P is a padlock SDI configuration, but all four tumblers are locked together and are turned by a single up arrows 516-U′, or a single down arrow 516-D′. For a small population of combination choices, this can provide a quicker selection by a user, presuming that additional information is required to be input following this section.

For SDI, a square keyboard or square keys can be a default starting position, with use of extensible markup language (“XML”) being used as the choice of circular (T/F) switching between that and regular keypad.

FIG. 5Q is a circular keypad 501-Q1 comprised of two concentric circles with radial lines drawn to create button areas for the data components of the SDI. The location of the radial lines changes to create different size buttons for the new SDI 501-Q2. The concentricity of the two circles can also change in another embodiment to create a new randomization in the display. The “0” index changes from T1 to T2 from 502-Q1 to 502-Q2.

The aforementioned FIGS. 5A through 5Q provide specific embodiments of the randomized SDIs.

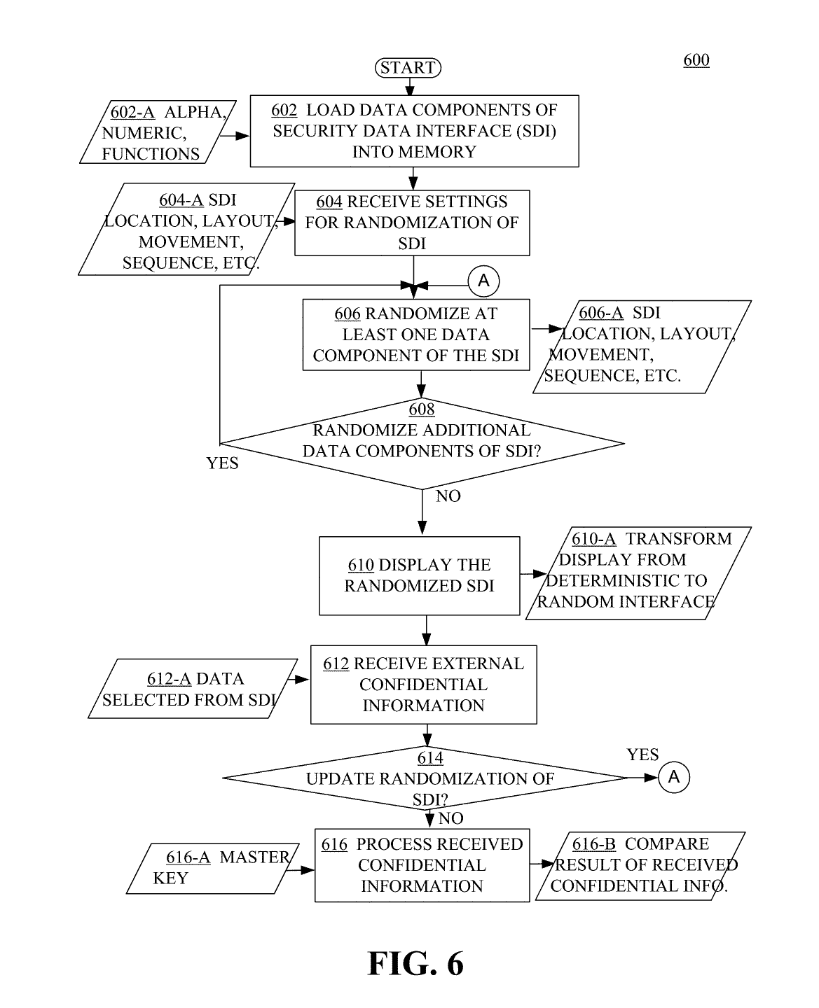

Referring now to FIG. 6, a flowchart 600 is shown of a method to randomize an SDI to provide secure entry and transmission of confidential information, according to one or more embodiments.

Flowchart 600 begins with operation 602 of loading 602-A data components, 102 of FIG. 1, for a security data interface (SDI) into memory 400 of FIGS. 2, and 3A to 3B, via user selection of a standard data component (numbers or alphabet, etc.), or via initialization from a remote host, e.g., enterprise server 201 of FIG. 2.

In operation 604, settings for randomization of the SDI are received 604-A from a user or host similar to the process of operation 602. The randomization settings include those listed as inputs 132 through 136 of FIG. 1, namely location, layout, movement, sequence, and UI factors of the SDI. The actual quantity and type of factors can vary greatly while retaining the user programmability and variability of combinations of the randomization factors.

Operation 606 randomizes at least one data component of the SDI, per the user programmability settings that are shown in FIG. 4D, and stored in memory 400 of electronic devices of FIGS. 2A and 3A to 3B.

Inquiry 608 asks if additional data components of SDI are to be randomized. Thus, if a linear translation is effected, but additional rotational, sequential, and key shape and size operations are still desired, these operations have to be executed prior to moving the SDI, or can be changed, as the SDI is moving, thus creating a slower and more gradual transition for the user, which might be less distracting.

In operation 610, the randomized SDI is displayed, where it transforms 610-A a display from a deterministic interface for inputting confidential information to a more random interface, and thus protecting the entry of the confidential information itself from compromise.

In operation 612 external confidential information is received, such as data selected from the SDI 612-A. Entries can be tokenized, masked, etc. to protect the substantive data. Operation 614 inquires whether the randomization of the SDI needs to be updated. If yes, then connector A returns to operation 606 to randomize the at least one data component of the SDI. This would be an appropriate step if, for example, a continuous floating SDI were programmed by the user, or if the user programmed a step update after entry of ‘X’ quantity of data entries from the SDI. For example, rotation updates can be programmed to move 0-n positions of the keys. As another example, if the data entered is CC information, then different CCs have different sets of identifying numbers, such that one CC will group four digits together while another CC will group three digits together. Thus, making a randomization step after three or four digit interval, or data input, helps to confirm the correct type of card was entered. Card type can be determined from first 2 numbers entered (Exam=34 or 37, Suppers=30, 36, 38), where Exam, Suppers would move after 4 digits then again after another 6 digits. Other card types (non-Exam) would move after each 4 digits. Changes can be activated based on a card type to match digits in each element. The randomness of the updates and the linear and rotational translations ensures that there is no consistent pattern or position implemented by the randomization algorithm.

If no update is required, then operation 616 processes the received confidential information. If the confidential information is for an account access, such as a user ID and a PW, then it is compared against a master key 616-A for a compare result 616-B of either pass or fail. If a credit card, then a LUHN filter is run on the submitted code to ensure validity, then the user name, account, etc. is checked for accuracy. If the confidential information is simply populating data, then the data is saved to the appropriate memory, as directed.

Exemplary pseudocode to launch initialization of the randomization process, including the size and location of the SDI as a circular keypad.

TABLE 1
Goto showKeypad( ) // Keypad is launched.
Function showKeypad( ):

| | |
|---|---|
| a. | If DispKeypadAtRandomLocation is true, then place the keypad at |
| | random location. |
| b. | If DispKeypadAtRandomLocation is false, then place the keypad in center |
| | of the screen. |
| c. | Initialize center point |
| d. | Initialize radius. |
| e. | Place the button position in random location. |
| | Random rndm = new Random( ); |
| | int i = rndm.Next(1, 9); |
| | double temp = 0; |
| | foreach (Button eachButton in listOfButtons) |
| | { |

if (temp == 1)
{
iCurrentRandomValue = i;
}
temp++;
i++;
eachButton.Location = new Point((int)(cntr.X + radius *

Math.Cos((angle * i) * Math.PI / 180)), (int)(cntr.Y + radius * Math.Sin((angle *
i) * Math.PI / 180)));

eachButton.Invalidate(true);

}

| f. | Keypad is launched. | |
|---|---|---|
| g. | IF PadlockEnable is enabled | |
| h. | Initialise padlock object. | |
| i. | Images in padlock are loaded from resources folder. | |
| j. | Set masking enable. | |
| k. | Show padlock dialog over keypad. The number of padlocks are displayed | |
| | based on a value configured for NumOfPadlocks. | |
| l. | IF OK button is clicked. | |
| m. | IF all padlocks are filled | |
| n. | Get the value and set to textbox of keypad. | |
| o. | ENDIF | |
| p. | ENDIF | |
| q. | ENDIF | |
| r. | IF PBX/DTMF is enabled, (Indicator is true and VoiceEnable is false) | |
| s. | Goto handlePBX( ) | |
| t. | Close the Keypad and set the value to textfield on HTML page. | |
| u. | ELSE IF PBX/Call Recorder is enabled (Indicator is true and VoiceEnable | |
| | is true) | |
| v. | Goto handlePBXCallRecorder( ) | |
| w. | Close keypad and set the value to textfield on HTML page. | |
| x. | END IF | |
| y. | Agent clicks on a button on the keypad (0-9), | |
| | i. | Set strValue += (value of button); |
| | ii. | IF KeypadInputMasked == true |

| | |
|---|---|
| 1. | Append * to the text field, and hold the value in object. |

| | iii. | END IF |
|---|---|---|
| | iv. | Goto handleRotationPatternsPerCard( ) |
| z. | IF cancel button on keypad clicked | |
| | i. | Close the keypad. |
| aa. | IF Clear button on keypad clicked. | |
| | i. | Clear the textbox on the keypad |
| | ii. | Clear the textfield value on the HTML page. |
| bb. | IF Back button on keypad clicked. | |
| | i. | Remove the last entered value from the textbox on keypad. |
| cc. | IF Enter button on keypad clicked. | |
| | i. | Goto Validate( ) |
| | ii. | IF tokentype == “Tokenization” |
| | iii. | Goto Tokenization( ) |
| | iv. | Set the token value returned to the textfield in HTML page. |
| | v. | ELSE IF tokentype == “Detokenization” |
| | vi. | Goto Detokenization( ) |
| | vii. | Set the card number value returned to the textfield in HTML page. |
| | viii. | ELSE |
| | ix. | Goto validate( ) |
| | x. | Close keypad, if validation is successful. |
| | xi. | Set the value entered using keypad to the textfield in HTML page. |
| | xii. | ENDIF |

| | |
|---|---|
| dd. | ENDIF |

Exemplary code to handle rotation patterns.

TABLE 2
Function handleRotationPatternsPerCard( ) // this will tell

| ee. | If DispNumberRandomly is true. | |
|---|---|---|
| | i. | IF(strValue.length % DispNumbersRandomlyAtEvery == |
| | | 0) |

| | |
|---|---|
| 1. | Goto RandomizeButtons( ) |
| 2. | Update UI buttons location for the list of buttons |
| | location. |

| | |
|---|---|
| | foreach (var point in listOfButtonsLocation) { |
| | //Update button location. |
| | } |
| ii. | END IF |

| | |
|---|---|
| ff. | Return |
| gg. | END IF |
| hh. | Goto RotateDial( ) |

Exemplary code to randomize buttons.

TABLE 2

Function RandomizeButtons( )
ii. Randomize the List of Buttons (0-9)

```
List<T> randomList = new List<T>( );
Random r = new Random( );
int randomIndex = 0;
while (inputList.Count > 0)
{
  randomIndex = r.Next(0, inputList.Count);
  randomList.Add(inputList[randomIndex]);
  inputList.RemoveAt(randomIndex);
}
```

Exemplary code to implement clockwise or anti-clockwise rotation.

TABLE 3
Function RotateDial( ) //Clockwise or anti clockwise

| jj. | IF(i % 2 == 0) //Clockwise. Value of i is generated using random | |
|---|---|---|
| | of 1 to 10 | |
| | i. | IF DoNotRotate == True |
| | ii. | Goto DoNotRotateClockwise( ) |
| | iii. | ELSE |
| | iv. | Goto RotateClockwise( ) |
| | v. | ENDIF |
| kk. | ELSE //Anti Clockwise | |
| | i. | IF DoNotRotate == True |
| | ii. | Goto DoNotRotateAntiClockwise( ) |
| | iii. | ELSE |
| | iv. | Goto RotateAntiClockwise( ) |
| | v. | ENDIF |

| | |
|---|---|
| ll. | ENDIF |

| | |
|---|---|
| mm. | Goto driftKeypad( ) |

### APPLICATIONS

References to methods, operations, processes, systems, and apparatuses disclosed herein that are implementable in any means for achieving various aspects, and may be executed in a form of a machine-readable medium, e.g., computer readable medium, embodying a set of instructions that, when executed by a machine such as a processor in a computer, server, etc. cause the machine to perform any of the operations or functions disclosed herein. Functions or operations may include receiving, intercepting, processing, encoding, decoding, transmitting, converting, communicating, transforming, synchronizing, calculating, terminating, compiling, associating, and the like.

The term “machine-readable” medium includes any medium that is capable of storing, encoding, and/or carrying a set of instructions for execution by the computer or machine and that causes the computer or machine to perform any one or more of the methodologies of the various embodiments. The “machine-readable medium” shall accordingly be taken to include, but not limited to, solid-state memories, optical and magnetic media, compact disc and any other storage device that can retain or store the instructions and information, e.g., only non-transitory tangible medium. The present disclosure is capable of implementing methods and processes described herein using transitory signals as well, e.g., electrical, optical, and other signals in any format and protocol that convey the instructions, algorithms, etc. to implement the present processes and methods.

Exemplary computing systems, such as a personal computer, minicomputer, mainframe, server, etc. that are capable of executing instructions to accomplish any of the functions described herein include components such as a processor, e.g., single or multi-processor core, for processing data and instructions, coupled to memory for storing information, data, and instructions, where the memory can be computer usable volatile memory, e.g. random access memory (RAM), and/or computer usable non-volatile memory, e.g. read only memory (ROM), and/or data storage, e.g., a magnetic or optical disk and disk drive). Computing system also includes optional inputs, such as alphanumeric input device including alphanumeric and function keys, or cursor control device for communicating user input information and command selections to processor, an optional display device coupled to bus for displaying information, an optional input/output (I/O) device for coupling system with external entities, such as a modem for enabling wired or wireless communications between system and an external network such as, but not limited to, the Internet. Coupling of components can be accomplished by any method that communicates information, e.g., wired or wireless connections, electrical or optical, address/data bus or lines, etc.

The computing system is only one example of a suitable computing environment and is not intended to suggest any limitation as to the scope of use or functionality of the present technology. Neither should the computing environment be interpreted as having any dependency or requirement relating to any one or combination of components illustrated in the exemplary computing system. The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The present disclosure is applicable to any type of network including the Internet, an intranet, and other networks such as local are network (LAN); home area network (HAN), virtual private network (VPN), campus area network (CAN), metropolitan area network (MAN), wide area network (WAN), backbone network (BN), global area network (GAN), or an interplanetary Internet. Communication media in the system can include wired, optical, wireless and other communication systems, e.g., voice over internet protocol (VOIP) that conveys data.

Methods and operations described herein can be in different sequences than the exemplary ones described herein, e.g., in a different order. Thus, one or more additional new operations may be inserted within the existing operations or one or more operations may be abbreviated or eliminated, according to a given application, so long as substantially the same function, way and result is obtained.

Although the present embodiments have been described with reference to specific example embodiments, it will be evident that various modifications and changes may be made to these embodiments without departing from the broader spirit and scope of the various embodiments.

For example, the various devices, modules, encoders, decoders, receivers, transmitters, servers, wireless devices, internal commutation systems, computers, etc. described herein may be enabled and operated using hardware circuitry (e.g., CMOS based logic circuitry), firmware, software and/or any combination of hardware, firmware, and/or software (e.g., embodied in a machine readable medium). Similarly, the modules disclosed herein may be enabled using software programming techniques. For example, the various electrical structure and methods may be embodied using transistors, logic gates, and electrical circuits (e.g., application specific integrated ASIC circuitry and/or in Digital Signal; Processor DSP circuitry).

The foregoing descriptions of specific embodiments of the present disclosure have been presented for purposes of illustration and description. They are not intended to be exhaustive or to limit the invention to the precise forms disclosed. Many modifications and variations are possible in light of the above teaching without departing from the broader spirit and scope of the various embodiments. The embodiments were chosen and described to explain best the principles of the invention and its practical application, and to enable others skilled in the art to best utilize the invention and various embodiments with various modifications as are suited to the particular use contemplated. It is intended that the scope of the invention be defined by the Claims appended hereto and their equivalents.

1. An electronic device for securely receiving confidential information, wherein the electronic device comprises:
a randomizer module to randomize information;
a memory for storing data components of a security data interface (SDI);
a display driver circuit (DDC); and wherein the electronic device is configured to:
randomize a display for at least one of the data components of the SDI such that at least one of the data components of the SDI is displayed in a randomized location; and
generate the SDI for the DDC by reading the data components of the SDI according to their display locations; and
the randomizer module transforms the display device from a deterministic display of the SDI to a randomized display of the SDI for secure receipt of the confidential information.

2. The electronic device of claim 1 wherein:
the SDI is configured as a circular layout of keys in a known apriori sequence as a visual aid; and
each key is a graphical boundary that contains a unique data component of the SDI.

3. The electronic device of claim 1 wherein:
the circular layout of keys in a known apriori sequence includes at least one repeated key that is in a sequence; and
the repeated key alters a count of the total number of keys in the data components of the SDI.

4. The electronic device of claim 1 wherein:
the randomizer is configured to generate updated positions in memory for each of the data components of the SDI; and
the position in memory cause the SDI to perform at least one of the following locational changes: translational movement, a clockwise rotational movement or counter-clockwise rotational movement.

5. The electronic device of claim 3 wherein:
the randomizer is configured to modify at least one of a size and a shape of one or more keys.

6. The electronic device of claim 3 wherein:
a change to the display of the data components of the SDI occurs in at least one of a continuous change during entry of the confidential information, or a step change after entry of a portion of the confidential information.

7. The electronic device of claim 1 further comprising:
a display device for displaying the SDI having at least one of the data components in a randomized location;
an input device to receive external information via the SDI; and wherein:
the SDI is a virtual data keypad (VDK);
the data components of the security data interface (SDI) stored in the memory include at least one of (i) a population of data entries; and (ii) a population of function entries; and
the external information selects one or more of the data components of the SDI as the confidential information.

8. The electronic device of claim 3 wherein:
a memory register to store parameter settings to programmably vary a degree of randomizing by the randomizing module for the display of the at least one of the data components of the SDI by one or more category of (i) a location of the SDI driven by the DDC; (ii) a layout of data components of the SDI driven by the DDC; (iii) a movement of the SDI by the DDC during receipt of external information on the SDI; and (iv) a sequence of the data components of the SDI as driven by the DDC.

9. The electronic device of claim 1 further comprising:
a comparator coupled to the input device; and wherein:
the input device receives a serial entry of single external inputs from a multiple choice format of the SDI;
the input device is a touch screen, mouse, or other selective input device;
the input device transmits the serial entry to the comparator; and
the comparator compares the serial entry of single external inputs to a security key for a match.

10. A method of securely receiving confidential information on an electronic device, the method comprising:
randomizing a display for at least one of a plurality of data components of the security data interface (SDI) such that at least one part of the SDI is displayed in a randomized location;
generating an SDI for a display driver circuit (DDC) to drive to a display device by reading the data components of the SDI according to their locations; and
transforming, via the randomizer module, a display device from a deterministic display of the SDI to a randomized display of the SDI for secure receipt of the confidential information.

11. The method of claim 10 further comprising:
displaying the SDI with the at least one randomized data component on the display device;
receiving external information on an input device via the SDI; and wherein:
the SDI is a virtual data keypad (VDK);
the external information selects of one or more of the data components of the SDI as the confidential information;
the SDI is configured as a circular layout of keys in a known apriori sequence as a visual aid; and
each key is a graphical boundary that contains a unique data component of the SDI.

12. The method of claim 10 further comprising:
configuring the randomizer module to randomize the display of the at least one of the data components of the SDI for (i) a location of the SDI driven by the DDC; (ii) a layout of data entry population (can still maintain the interrelational location) of the SDI driven by the DDC; (iii) a movement of the SDI by the DDC during receipt of external entries on the SDI; and (iv) a sequence of the components of the SDI as driven by the DDC.

13. The method of claim 10 further comprising:
receiving at an input device, a serial entry of single external inputs from a multiple choice format of the SDI;
transmitting the serial entry from the input device to the comparator;
comparing via a comparator the serial entry of single external inputs to a security key disposed in memory, for a match; and
transforming the electronic device from a locked state to an unlocked state if the serial external inputs match the security key; and wherein:
the input device is a touch screen, mouse, or other selective input device; and

14. The method of claim 10 further comprising:
the circular layout of keys in a known apriori sequence includes at least one repeated key that is in a sequence; and
the repeated key alters a count of the total number of keys in the data components of the SDI.

15. The method of claim 10 further comprising:
the randomizer is configured to generate updated positions in memory for each of the data components of the SDI; and
the position in memory cause the SDI to perform at least one of the following locational changes: translational movement, a clockwise rotational movement or counter-clockwise rotational movement.

16. The method of claim 10 further comprising:
the randomizer is configured to modify at least one of a size and a shape of one or more keys while retaining a same anchor location on a display of the electronic device.

17. The method of claim 10 further comprising:
a change to the display of the data components of the SDI occur in at least one of a continuous change during entry of the confidential information, or a step change after entry of a portion of the confidential information.

18. A system for securely receiving confidential information, wherein the system comprises:
a server comprising:
a randomizer module to randomize information;
a memory for storing data components of a security data interface (SDI);
a display driver circuit (DDC); and wherein the electronic device is configured to:
randomize a display location for at least one of the data components of the SDI such that at least one part of the SDI is displayed in a randomized location;
generate an SDI for the DDC to drive by reading the data components of the SDI according to their locations.

19. The system of claim 18, further comprising:
an electronic device coupled to the server and comprising:
a display device for displaying the SDI having at least one of the data components in a randomized location;
an input device to receive external information via the SDI; and wherein:
the SDI is a virtual data keypad (VDK); and
the data components of the security data interface (SDI) received at the electronic device include at least one of (i) a population of numeric or alphabet data entries; and (ii) a population of function entries;
the external information selects one or more of the data components of the SDI as the confidential information; and
the randomizer transforms the display device from a deterministic display of the SDI to a randomized display of the SDI for secure receipt of the confidential information.

20. The system of claim 18 wherein:
the randomizer module is configured to randomize one or more components of (i) a location of the SDI driven by the DDC; (ii) a layout of data entry population of the SDI driven by the DDC; (iii) a movement of the SDI by the DDC during receipt of external information on the SDI; and (iv) a sequence of the components of the SDI as driven by the DDC.
